(19) United States
(12) Patent Application Publication
(10) Pub. No.: US 2015/0302059 A1
(43) Pub. Date: Oct. 22, 2015

(54) CONTENT RECOMMENDATION APPARATUS AND THE METHOD THEREOF

(71) Applicant: Samsung Electronics Co., Ltd., Suwon-si (KR)

(72) Inventors: Kang-rok LEE, Seongnam-si (KR); Jong-ho LEA, Seongnam-si (KR)

(73) Assignee: Samsung Electronics Co., Ltd., Suwon-si (KR)

(21) Appl. No.: 14/688,444

(22) Filed: Apr. 16, 2015

(30) Foreign Application Priority Data
Apr. 16, 2014 (KR) 10-2014-0045567
Apr. 10, 2015 (KR) 10-2015-0050994

(51) Int. Cl. G06F 17/30

(52) U.S. Cl. CPC G06F 17/30507; G06F 17/30528

(57) ABSTRACT

A content recommendation apparatus includes a data collector configured to collect user information and process the collected user information as user context data; a query generator configured to generate a query for searching a content based on the user information and the user context data; and a controller configured to generate a decision rule to decide whether a content searched based on the generated query satisfies at least one of the user information and the user context data, and provide a content which satisfies the decision rule.

### CROSS-REFERENCE TO RELATED APPLICATIONS

This application claims the priority benefit of Korean Patent Application No. 10-2014-0045567, filed in the Korean Intellectual Property Office on Apr. 16, 2014, and Korean Patent Application No. 10-2015-0050994, filed in the Korean Intellectual Property Office on Apr. 10, 2015, the disclosures of which are incorporated herein by reference.

### BACKGROUND

1. Field

The following description relates to a content recommendation apparatus and the method thereof, and more particularly, to a content recommendation apparatus providing a recommended content based on context data of a user and the method thereof.

2. Description of the Related Art

Thanks to the development of the Internet, recently a user can use a variety of content, and an IPTV service among content providing services through the Internet is being widely used. Particularly, due to the advent of an IPTV and a Smart TV by a fusion of multi-channels, multimedia, and broadcasting communications, a large amount of TV programs and content are provided to a viewer.

As the content provided to the user increases, along with number of the content-providing service through IPTV or Smart TV services widely used, it has gradually become difficult for the user to selectively receive content the user desires.

In order to solve this issue, a service which recommends content to the user was requested, and a service recommending a content similar to a viewing content of the user based on the viewing content of the user has been developed.

However, the related art recommends content based merely on a viewing content of the user without recognizing a situation of the user requesting content. Therefore, the related art has a limitation in recommending content according to the user's true intention.

### SUMMARY

Additional aspects and/or advantages will be set forth in part in the description which follows and, in part, will be apparent from the description, or may be learned by practice of the invention.

The purpose of the exemplary embodiments is to provide a content recommendation apparatus capable of recommending content according to a query based on context data of a user, and the method thereof.

According to exemplary embodiments, a content recommendation apparatus includes a data collector configured to collect context data of a user, a query generator configured to generate a query for searching content based on the collected context data, and a controller configured to provide a recommend content searched based on the generated query.

The apparatus may further include a communicator configured to communicate with a content providing apparatus. The controller may transmit the generated query to the content providing apparatus, receive the recommended content searched based on the query from the content providing apparatus, and provide the recommended content.

The controller may check whether the content received from the content providing apparatus corresponds to the generated query, and in response to the content received from the content providing apparatus not corresponding to the generated query, re-request for a recommended content corresponding to the generated query from the content providing apparatus.

The controller may control the query generator to extract data which meets predetermined requirements from the collected context data and to generate the query based on the extracted data.

The controller may control the query generator to convert the collected context data into text data and to generate the query based on the converted text data.

The apparatus may include a storage unit configured to store user information. The controller may control the query generator to generate a query for searching a content based on the collected context data and the user information.

The user information may include at least one of a gender, an age, an occupation, an income, a voice pattern, a motion pattern, and a face pattern of the user.

The context data may include data of at least one of a voice, a motion, a posture, a facial expression, a viewing content, and a viewing pattern of the user.

According to an exemplary embodiment, a content recommendation apparatus includes a data collector configured to collect user information and process the collected user information as user context data; a query generator configured to generate a query for searching a content based on the user information and the user context data; and a controller configured to generate a decision rule to decide whether a content searched based on the generated query satisfies at least one of the user information and the user context data, and provide a content which satisfies the decision rule.

Here, the user context data may include user context log data and user context test data, wherein the controller may extract the user context test data which satisfies a preset condition from among the user context log data, and generate the decision rule based on at least one of the user information and the user context test data.

The apparatus according to an exemplary embodiment further includes a communicator configured to perform communication with a content providing apparatus; wherein the controller may transmit the generated query to the content providing apparatus, receive the recommended content searched based on the query from the content providing apparatus, and provide the content.

The controller may check whether the content received from the content providing apparatus satisfies the decision rule, and in response to the content received from the content providing apparatus not satisfying the decision rule, re-request for a content satisfying the generated decision rule from the content providing apparatus.

The controller may control the query generator to extract data which meets predetermined requirements from the user context data and to generate the query based on the extracted data.

The extracted data may include information regarding the decision rule.

The apparatus according to an exemplary embodiment further includes a storage unit, wherein the controller may store the user information and the user content data in which the user information is processed to the storage unit.

The user context data may include user context log data and user context test data, wherein the controller may store each of the user context log data and the user context test data by preset groups.

The user information may include at least one of a gender, an age, an occupation, an income, a voice pattern, a motion pattern, and a face pattern of the user.

The user context data may include data of at least one of a voice, a motion, a posture, a facial expression, a viewing content, and a viewing pattern of the user.

A method of a controlling a content recommendation apparatus according to an exemplary embodiment includes collecting user information; processing the collected user information to user context data; generating a decision rule based on at least one of the user information and the user context data; generating a query for searching a content based on the user information and the context data; determining whether a content searched based on the generated query satisfies the decision rule; and providing a content which satisfies the decision rule.

The user context data may include user context log data and user context test data,

wherein the generating the decision rule may include extracting the user context test data which satisfies a preset condition from among the user context log data, and generating the decision rule based on at least one of the user information and the user context test data.

The method according to an exemplary embodiment further includes performing communication with a content providing apparatus; wherein the providing may include transmitting the generated query to the content providing apparatus, receiving the content searched based on the query from the content providing apparatus, and providing the d content.

The method according to an exemplary embodiment may further include checking whether a content received from the content providing apparatus satisfies the generated decision rule; and re-requesting for a content satisfying the generated decision rule to the content providing apparatus in response to the received content not satisfying the generated decision rule.

The generating may include extracting data which meets predetermined requirements from the user context data, and generating the query based on the extracted data.

The extracted data may include information regarding the decision rule.

The method according to an exemplary embodiment may further include storing the user information and the user context in which the user information is processed.

The user context data may include user context log data and user context test data, wherein the storing may include storing each of the user information, the user context log data, and the user context test data by preset groups.

The user information may include at least one of a gender, an age, an occupation, a voice pattern, a motion pattern, and a face pattern of the user.

The context data may include data of at least one of a voice, a motion, a posture, a facial expression, a viewing content, and a viewing pattern of the user.

According to exemplary embodiments, a recommended content corresponding to the user's intention can be provided because the content recommendation apparatus recognizes a situation of the user requesting content and provides a recommended content.

### BRIEF DESCRIPTION OF THE DRAWINGS

The above and/or other aspects of the present disclosure will be more apparent by describing certain present disclosure with reference to the accompanying drawings, in which:

FIG. 1 is a block diagram of a content recommendation system according to an exemplary embodiment;

FIG. 2 is a block diagram of a content recommendation apparatus according to an exemplary embodiment;

FIG. 3 is a block diagram of a content recommendation system according to an exemplary embodiment;

FIG. 4 is a block diagram for illustrating a database according to an exemplary embodiment;

FIG. 5 is a flowchart illustrating a controlling method of a content recommendation apparatus according to an exemplary embodiment;

FIG. 6 is a flowchart illustrating a method of extracting context test data according to an exemplary embodiment;

FIG. 7 is a flowchart illustrating a checking method of a recommended content according to an exemplary embodiment;

FIG. 8 is a detailed view illustrating a content recommendation system according to an exemplary embodiment;

FIG. 9 is a view illustrating a process to check whether the decision rule is satisfied according to an exemplary embodiment; and

FIG. 10 is a flowchart illustrating a controlling method of a content recommendation apparatus according to an exemplary embodiment.

### DETAILED DESCRIPTION

Reference will now be made in detail to the embodiments, examples of which are illustrated in the accompanying drawings, wherein like reference numerals refer to like elements throughout. The embodiments are described below to explain the present disclosure by referring to the figures.

Hereinafter, exemplary embodiments will be described in detail with reference to the accompanying drawings.

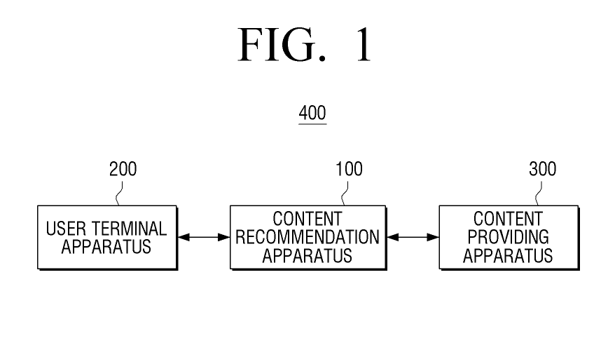

FIG. 1 is a block diagram illustrating a content recommendation system 400 according to an exemplary embodiment. Referring to FIG. 1, the content recommending system 400 includes a user terminal apparatus 200, a content recommending apparatus 100, and a content providing apparatus 300.

The user terminal apparatus 200 is an element configured to display content. The user terminal apparatus 200 may be a device such as a smart phone, a smart TV, or a tablet PC, for example.

Specifically, the user terminal apparatus 200 may include a camera taking a picture of a user, and a microphone inputting a sound, etc. Accordingly, the user terminal apparatus 200 may input context data through the camera or the microphone while displaying content. In this regard, the context data may include at least one of a voice, a motion, a posture, a facial expression, a viewing content, and a viewing pattern of the user, for example. Thus, the user terminal apparatus 200 inputs the context data of the viewing pattern of the user, etc. while displaying the content. The user terminal apparatus 200 transmits such various context data to the content recommendation apparatus 100.

The content recommendation apparatus 100 is connected to the user terminal apparatus 200 by a cable or a wireless system and receives the context data. The content recommendation apparatus 100 may recommend a content corresponding to the received context data.

Specifically, the content recommendation apparatus 100 generates a query for searching content based on the received context data. In this regard, the content recommendation apparatus 100 may store context test data, and receive context log data from the user terminal apparatus 200. The content recommendation apparatus 100 compares the context log data with the context test data, and determines the context log data matching the context test data to be a valid input. Accordingly, the content recommendation apparatus 100 extracts the context log data matching the context test data, and generates a query for recommending content using the extracted context log data. In this regard, the generated query may be generated based on at least one context log data or at least one of the previously stored user information. The user information may refer to user information of a registered user.

However, the content recommendation apparatus 100 recommends a content based on the context data received from the user terminal apparatus 200. Specifically, the content recommendation apparatus 100 searches a content using the generated query. As described above, the query may be generated by a combination of at least one of the context log data, a combination of at least one of the user information data, and a combination of the context log data and the user information data. Therefore, the content recommendation apparatus 100 searches recommended content using the generated query. In this regard, the content recommendation apparatus 100 may pre-store the query and the content search result based the user information data or the context log data received from a plurality of the user terminal apparatuses 200. Accordingly, the content recommendation apparatus 100 may request for the content recommended by the search result to the content providing apparatus 300.

The content providing apparatus 300 provides the content requested by the content recommendation apparatus 100. That is, the content recommendation apparatus 10 transmits a signal for requesting for the searched recommended content to the content providing apparatus 300. The content providing apparatus 300 which receives the signal for requesting for the content transmits the requested content to the content recommendation apparatus 100.

However, the content recommendation apparatus 100 which receives the content from the content providing apparatus 300 determines whether the received content corresponds to the generated query. The content recommendation apparatus 100 transmits the received content to the user terminal apparatus 200 in response to the received content corresponding to the generated query. However, the content recommendation apparatus 100 may not transmit the received content to the user terminal apparatus 200, and may re-request for content corresponding to the generated query in response to the received content not corresponding to the generated query.

Hereinbefore, the content recommendation system 400 was described in outline according to an exemplary embodiment. Hereinafter, the content recommendation apparatus 100 will be explained in more detail with reference to the accompanying drawings.

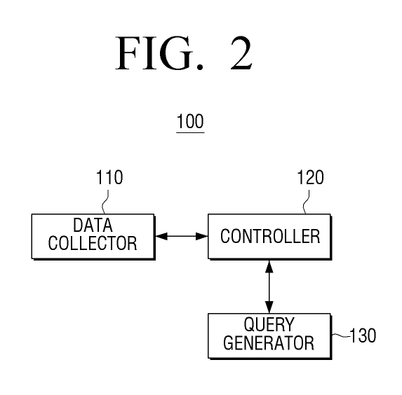

FIG. 2 is a block diagram illustrating the content recommendation apparatus 100 according to an exemplary embodiment. Referring to FIG. 2, the content recommendation apparatus 100 includes a data collector 110, a controller 120, and a query generator 130.

The data collector 110 is an element configured to collect context data of the user. Specifically, the data collector 110 receives the context data of the user from the user terminal apparatus 200, and in this regard, the context data may refer to data of a viewing pattern of the user. Accordingly, the data collector 110 receives the context data which may be data of a voice, a motion, a posture, a facial expression, and a viewing content of the user's viewing pattern, for example, from the user terminal apparatus 200. For example, the context data collected by the data collector 110 may refer to the information on the user, the time of day, a motion of switching channels for searching a food program, and a motion of lying down and viewing.

The controller 120 may extract data which meets predetermined requirements from the collected context data. That is, the controller 120 may only use the context data which meets the predetermined requirements to generate a query for recommending content. Accordingly, because meaningless or unnecessary data for the content recommendation may be excluded from the collected context data, the user's situation may be determined accurately and the recommended content corresponding to the user's intention may be provided.

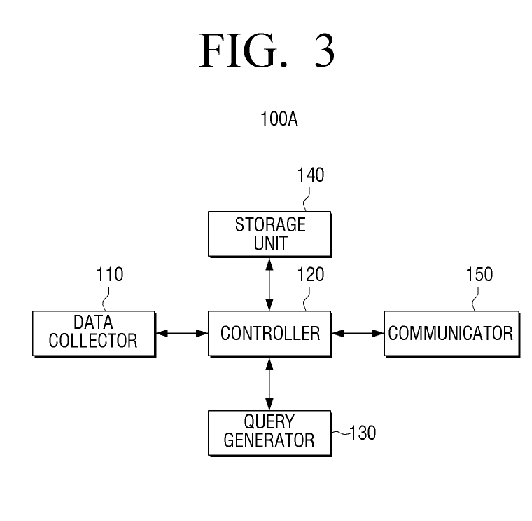

Specifically, the context data transmitted to the data collector 110 is context log data, and the context log data is converted into context test data. Thus, all raw data regarding the user's viewing pattern may be the context log data, and the context log data except for unnecessary or meaningless data may be converted into the context test data. This will be explained in detail below with reference to FIG. 3.

The query generator 130 is an element configured to search a content based on the collected context data. Thus, the controller 120 controls the query generator 130 to generate a query for searching a content using the context data received from the data collector 110. Specifically, the controller 120 may control the query generator 130 to extract data which meets the predetermined requirements from the collected context data and to generate a query based on the extracted data.

Meanwhile, the controller 120 may convert the collected context data into text data. Accordingly, the controller 120 may control the query generator 130 to generate a query based on the converted text data. For example, in the above-described example, the controller 120 may control the query generator 130 to generate a query on “a recommendable content for a first user who intends to view a food program while lying down in the evening time.”

According to the above method, the controller 120 searches a recommended content based on the generated query in response to a query generated by the query generator 130. Therefore, the controller 120 controls the query generator 130 to generate a query based on the context data, and then searches a recommended content corresponding to the generated query. Accordingly, the controller 120 requests for the searched recommended content to the content providing apparatus 300. The content providing apparatus 300 transmits the requested recommended content to the content recommendation apparatus 100, and the controller 120 receives the recommended content.

In addition, the controller 120 may transmit the query generated from the query generator 130 to the content providing apparatus 300. The content providing apparatus 300 which receives the query may search a recommended content corresponding to the query, and may transmit the searched recommended content to the content recommendation apparatus 100.

According to the method, the content recommendation apparatus 100 in accordance with an exemplary embodiment may determine a situation of a user accurately, and may provide a recommended content corresponding to the user's intention.

FIG. 3 is a block diagram illustrating a content recommendation apparatus 100A according to an exemplary embodiment. Referring to FIG. 3, the content recommendation apparatus 100A may further include a storage unit 140 and a communicator 150. Hereinafter, an explanation overlapped with the explanation of FIG. 2 will be omitted.

The communicator 150 is an element configured to communicate with the content providing apparatus 300. The communicator 150 may communicate with the user terminal apparatus 200 through various communication protocols such as HTTP (Hyper Text Transfer Protocol), XMPP (Extensible Messaging and Presence Protocol), SSL (Secure Sockets Layer), FTP (File Transfer Protocol), and CCN (Content Centric Networking), for example. However, the present disclosure is not limited to these protocols, and the communicator 150 may communicate wirelessly with the content providing apparatus 300 according to various wireless communications bases such as Wi-Fi, 3G (3rd Generation), 3GPP (3rd Generation Partnership Project), and LTE (Long Term Evolution), for example.

The controller 120 may search recommended content using a query generated from the query generator 130. In this case, the content recommendation apparatus 100A searches recommended content, and transmits a signal for requesting the searched recommended content to the content providing apparatus 300 through the communicator 150. The content providing apparatus 300 may transmit the requested content to the communicator 150 of the content recommendation apparatus 100A.

In addition, the controller 120 transmits the generated query to the content providing apparatus 300, and provides the recommended content searched based on the query from the content providing apparatus 300. In this case, the content recommendation apparatus 100A may provide a query for searching recommended content through the communicator 150, and the content providing apparatus 300 may search recommended content based on the provided query and then may transmit the searched recommended content to the communicator 150 of the content recommendation apparatus 100A.

The storage unit 150 is an element configured to store user information. The user may input the user information into the user terminal apparatus 200. The user terminal apparatus 200 may transmit the inputted user information to the content recommendation apparatus 100A, and the received user information may be stored in the storage unit 140. In this case, the storage unit 140 may group the user of the user terminal apparatus 200 into one group. For instance, as a user of a TV, a first terminal, is grouped into Group 1, the user of Group 1 may be set with a family member using the first terminal apparatus. Similarly, as a user of a smart phone, a second terminal, may be grouped into Group 2, the user of Group 2 may be set with a user using the second terminal apparatus.

Some of the user information as above may be used for a query for searching recommended content. The user information may include at least one of a gender, an age, an occupation, income, a voice pattern, a motion pattern, and a face pattern of the user, for example. Accordingly, the controller 120 controls the query generator 130 to generate a query for searching a recommended content using the user information stored in the storage unit 140.

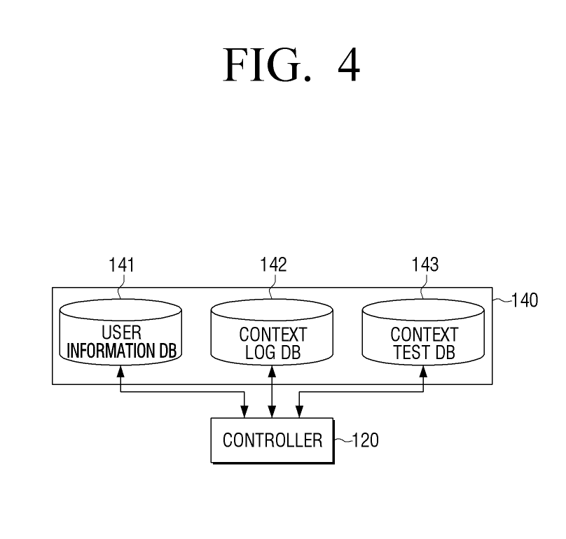

However, the storage unit 140 may store the context data other than the user information. Accordingly, the controller 120 controls the query generator 130 to generate a query for searching a content based on the context data and the user information. This will be explained in detail with reference to FIG. 4.

Meanwhile, the controller 120 may check whether the received recommended content corresponds to the query. Thus, the controller 120 checks whether the recommended content received from the content providing apparatus 300 through the communicator 150 corresponds to the generated query. The controller 120 transmits the received recommended content to the user terminal apparatus 200 in response to the received recommended content corresponding to the generated query. Otherwise, the controller 120 controls the query generator 130 to generate another query in response to the received recommended content not corresponding to the generated query. In this case, the query generator 130 may generate a new query by changing the order of the collected context data, and may generate a new query by deleting the context data of a lower priority from the collected context data. Thus, the method of re-searching and re-requesting for content according to a new query is identical to the above-described method.

FIG. 4 is a block diagram illustrating a storage unit 140 according to an exemplary embodiment. Referring to FIG. 4, the storage unit 140 stores user information DB 141, context log DB 142, and context test DB 143.

The user information DB 141 includes the user information received from the user terminal apparatus 200. At least one of the user information may be used for a query for searching recommended content. The user information may include at least one of a gender, an age, an occupation, income, a voice pattern, a motion pattern, and a face patter of the user, for example.

Accordingly, the controller 120 may control the query generator 130 to generate a query for searching recommended content based on the user information included in the user information DB 141. For example, a query based on the user information may be a query on “a recommendable content for a 35 year old man earning 50,000 dollars a year and working in a research team.”

However, the controller 120 may control the query generator 130 to generate a query for searching recommended content based on the context data. In this regard, the context data may refer to the data of the user's viewing pattern. Such context data is classified into the context log data and the context test data, and each of the types of data is included in the context log DB 142 and the context test DB 143, respectively.

The context log DB 142 includes the context log data received from the user terminal apparatus 200. The context log data may refer to various types of the context data captured and collected by the user terminal apparatus 200. The context log data may include the information on the user's viewing pattern such as a voice, a motion, a posture, a facial expression, and a viewing content, for example.

However, not all the received context log data is used for generating a query. Thus, the controller 120 may extract the data which meets the predetermined requirements from the received context log data, and the data meeting the predetermined requirements is included in the context test DB 143.

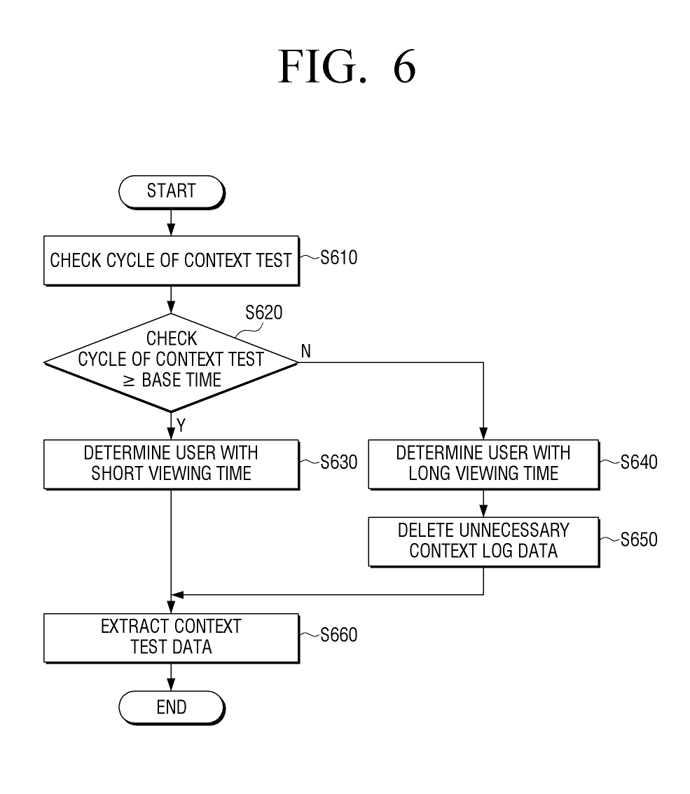

For example, a motion of moving a face temporarily among the user's viewing pattern, and a content selected temporarily for searching a channel are regarded as unnecessary or meaningless data for recommending content. Accordingly, the controller 120 extracts context test data which is significant for recommending content from the context log data. The extracted context test data is included in the context test DB 143, and the method of extracting context test data will be explained in detail with reference to FIG. 6.

Accordingly, the controller 120 may not control the query generator 130 to generate a query for searching a recommended content using the context log data, but instead the controller 120 may control the query generator 130 to generate a query by extracting context test data which refers to valid data from the context log data and using the extracted context test data. For example, the query based on the context log data and the context test data may be a query on “a recommendable content for a first user watching a food program lying down in the evening time.”

However, the controller 120 may control the query generator 130 to generate a query by combining the user information and the context data. The user information and the context data are the same as described above, and the user information and the context data may be combined to search a recommended content. For example, a query on “a recommendable content for a 35 years old man earning 50,000 dollars a year working in a research team and watching a food program lying down in the evening time” may be generated.

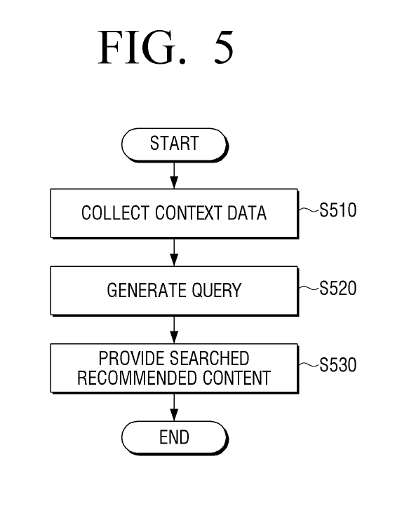

FIG. 5 is a flowchart illustrating a controlling method of the content recommendation apparatuses 100 and 100A according to an exemplary embodiment. Hereinafter, an explanation overlapped with the above-described explanation will be omitted.

The content recommendation apparatuses 100 and 100A collect context data of the user (operation S510). In this case, the context data may include data of at least one of a voice, a motion, a posture, a facial expression, a viewing content, and a viewing pattern of the user, for example.

The content recommendation apparatuses 100 and 100A generate a query for searching a content based on the collected context data (operation S520). In this regard, the content recommendation apparatuses 100 and 100A may extract the data which meets the predetermined requirements from the collected context data and may generate a query based on the extracted data.

On the other hand, the content recommendation apparatuses 100 and 100A may convert the collected context data into text data, and may generate a query based on the converted text data.

However, the content recommendation apparatuses 100 and 100A may store the user information. In this case, the content recommendation apparatuses 100 and 100A may generate a query for searching a content based on the collected context data and the user information. The user information may include at least one of a gender, an age, an occupation, income, a voice pattern, a motion pattern, and a face pattern of the user, for example.

The content recommendation apparatuses 100 and 100A provide a recommended content searched based on the generated query (operation S530).

On the other hand, the content recommendation apparatuses 100 and 100A may communicate with the content providing apparatus 300. In this case, the content recommendation apparatuses 100 and 100A may transmit the generated query to the content providing apparatus 300, may receive the recommended content searched based on the query from the content providing apparatus 300, and may provide the recommended content.

However, the content recommendation apparatuses 100 and 100A may check whether the content received from the content providing apparatus 300 corresponds to the generated query. In this case, the content recommendation apparatuses 100 and 100A may re-request for a recommended content corresponding to the generated query to the content providing apparatus 300 in response to the received content not corresponding to the generated query.

FIG. 6 is a flowchart illustrating a method of extracting the context test data according to an exemplary embodiment.

The content recommendation apparatuses 100 and 100A receive context data from the user terminal apparatus 200 to generate a query for searching content. As described above, the context data is the data of the user's viewing pattern, and the context data is classified into the context log data and the context test data.

The context log data may refer to various types of context data captured and collected by the user terminal apparatus 200. In this regard, the content recommendation apparatuses 100 and 100A may extract the data which meets the predetermined requirements from the collected context log data. Thus, the content recommendation apparatuses 100 and 100A may generate a query for searching a recommended content by setting the data meeting the predetermined requirements as the context test data, and by extracting data corresponding to the context test data from the context log data received from the user terminal apparatus 200. Hereinafter, the method of extracting the context test data from the context log data will be explained in detail.

Referring to FIG. 6, the content recommendation apparatuses 100 and 100A set a base time (not shown). The base time may be set differently according to the user terminal apparatus 200 or the content recommendation apparatuses 100 and 100A. The content recommendation apparatuses 100 and 100A may check a cycle of the context test for each user (operation S610).

The content recommendation apparatuses 100 and 100A compare the cycle of the context test and the predetermined base time (operation S620). The content recommendation apparatuses 100 and 100A may determine that the user has a short viewing time (operation S630) in response to the cycle of the text longer than the base time (operation S620_Y). In this case, the content recommendation apparatuses 100 and 100A may extract the context test data from the received context log data (operation S660) and may store the context test data in the context test DB 143.

The content recommendation apparatuses 100 and 100A may determine that the user has a long viewing time (operation S640) in response to the cycle shorter than the base time (S620_N). In this case, the content recommendation apparatuses 100 and 100A may delete unnecessary or meaningless data from the received context log data (operation S650). Thus, the content recommendation apparatuses 100 and 100A may delete the data not corresponding to the stored context test data from the received context log data. The context recommendation apparatuses 100 and 100A may extract the context test data from the remaining context log data after deleting the unnecessary or meaningless data from the received context log data (operation S660), and may store the context test data in the context test DB 143.

However, among the context log data not corresponding to the context test data, the context log data related to the context selection may be stored in the context log DB 142 and the context test data may be extracted from the context log data for sure.

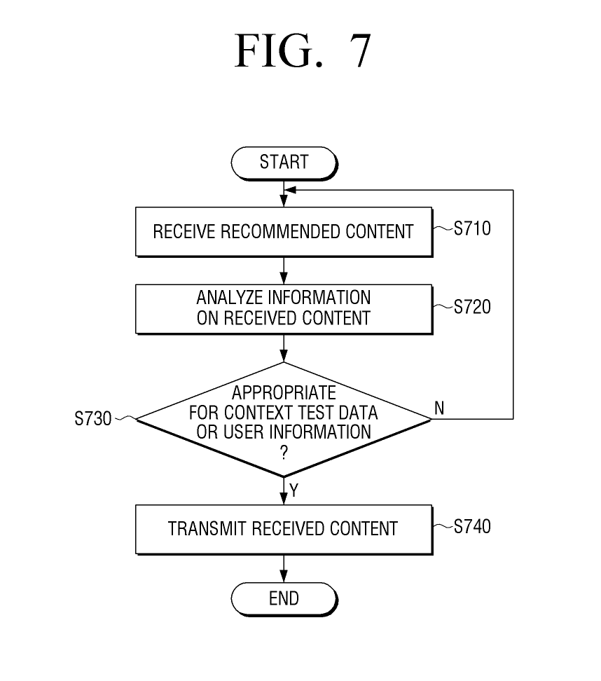

FIG. 7 is a flowchart illustrating a method of checking a recommended content of the content recommendation apparatuses 100 and 100A according to an exemplary embodiment. Hereinafter, the method of checking whether a recommended content received from the content providing apparatus 300 corresponds to a query will be explained.

The content recommendation apparatuses 100 and 100A generate a query for searching a recommended content based on the context data (not shown). In this case, the content recommendation apparatuses 100 and 100A search a recommended content corresponding to the generated query and also the content providing apparatus 300 may do the same, as described above. Accordingly, the content recommendation apparatuses 100 and 100A may receive the recommended content searched according to the query (operation S710). In this regard, the received recommended content may include not only the content, but may also include the properties of the content.

The content recommendation apparatuses 100 and 100A analyze the information of the received content (operation S720) and determine whether the content corresponds to the query (operation S730). In this regard, the content recommendation apparatuses 100 and 100A may determine the adequacy of the content by comparing the content information with the context data in response to a query generated based only on the context data. The content recommendation apparatuses 100 and 100A may determine the adequacy of the content by comparing the content information with the user information in response to a query generated based only on the user information. In addition, the content recommendation apparatuses 100 and 100A may determine the adequacy of the content by comparing the content information, the user information and the context data in response to a query generated based on a combination of the user information and the context data. Accordingly, the content recommendation apparatuses 100 and 100A transmit the received recommended content to the user terminal apparatus 200 (operation S740) in response to the received recommended content corresponding to the query (operation S730_Y).

However, the content recommendation apparatuses 100 and 100A may re-search and re-request for a recommended content corresponding to the query, and may receive the recommended content (operation S710) in response to the received recommended content not corresponding to the query (operation S740_N).

In this regard, the content recommendation apparatuses 100 and 100A may generate a query different from the previously generated query. For example, the content recommendation apparatuses 100 and 100A may generate a new query by changing the order of the context data. In addition, the content recommendation apparatuses 100 and 100A may generate a new query based on at least one piece of data deleted from a plurality of the context data. Moreover, the content recommendation apparatuses 100 and 100A may set a priority of the plurality of the context data, and may generate a new query based on the remaining data after the context data of the lower priority is deleted.

As described above, FIGS. 1-7 describe an exemplary embodiment of determining whether the content received by the controller 120 of the content recommendation apparatus (100) from the content providing apparatus 300 corresponds to a query.

Meanwhile, as an example, the controller 120 of the content recommendation apparatus 100 may generate a query to search for a content and generate a decision rule to decide whether a content searched based on the generated query satisfies at least one of the user information and the user context data. This will be explained in greater detail.

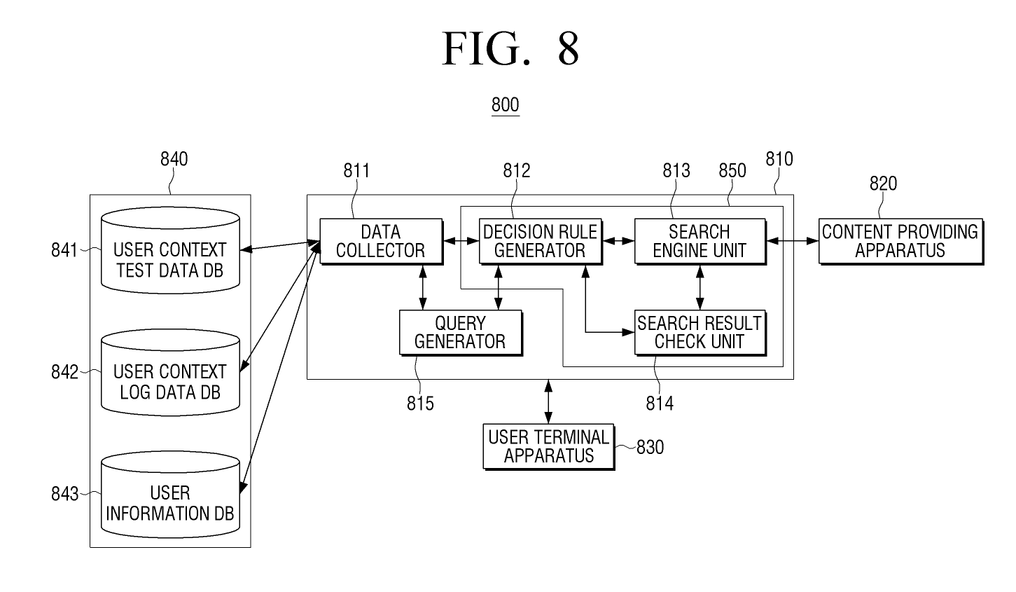

FIG. 8 is a detailed view illustrating a content recommendation system according to an exemplary embodiment.

Referring to FIG. 8, the content recommendation system 800 includes a server 810, a content providing apparatus 820, and a user terminal apparatus 830. Here, the server 810, the content providing apparatus 820, and the user terminal apparatus 830 may respectively correspond to the content recommendation apparatus 100, the content providing apparatus 300, and the user terminal apparatus 200 as described in FIG. 1. In addition, in FIG. 8, the content recommendation apparatus 100 is embodied as the server 810, but is not limited thereto, and may be embodied as another type of terminal apparatus or computer.

To be specific, the server 810 includes a data collector 811, a query generator 815, and a controller 850. Here, the data collector 811, the query generator 815, and the controller 850 may correspond to the data collector 110, the query generator 130, and the controller 120 as described in FIGS. 2-3.

Meanwhile, the data collector 811 may collect user information and process the collected user information as user context data.

The query generator 815 may generate a query for searching a content based on the user information and the user context data.

The controller 850 may generate a decision rule to decide whether a content searched based on the generated query satisfies at least one of the user information and the user context data, and provide a content which satisfies the decision rule.

To be specific, the user context data may include user context log data and user context date data, and the controller 810, from among user context log data, may extract the user context data which satisfies a preset condition and generates the decision rule based on at least one of the user information and the user context data.

Here, user information may include at least one of personal information, a gender, an age, an occupation, an income, a voice pattern, a motion pattern, and a face pattern of a user. In addition, the user context data may include data of at least one of a voice, a motion, a posture, a facial expression, a viewing content, and a viewing pattern of a user. In particular, the user context data, as described above, may include the user context data and the user context test data, user context log data is data regarding a voice, a motion, a posture, a facial expression of a user which are input through an input sensor, and a viewing contents, viewing pattern, viewing time, and viewing cycle of a user which are input through a remote controller, and the user context text data is data detected from the above-described user context log data according to a preset condition. The process of extracting the context test data is, as described in FIG. 6, may include a process where data which satisfies a reference time is extracted only from data regarding a viewing cycle from among the context log data and this data becomes a user context test data regarding a viewing frequency.

As such, a reason why extracting context test data which satisfies a preset condition from context log data is that, for example, a user's facial expression or a motion cannot be determined appropriately under a dark environment, and a user's circumstance cannot be determined appropriately when a third party changes meaninglessly for channel search, and thus, the context log data corresponding to this condition needs to be excluded when recommending appropriate contents that suit for a user's circumstance.

Accordingly, the controller 850 may extract the user context test data which satisfies a preset condition from among the user context log data, and generate the decision rule based on at least one of the user information and the user context test data.

The server 810 may further include a communicator (not shown) which communicates with the content providing apparatus 820, and the controller 850 the controller 850 may transmit the generated query to the content providing apparatus 820, receive from the content providing apparatus the content searched based on the query and provide to the user terminal apparatus 830.

In addition, the controller 850 may check whether the content received from the content providing apparatus 820 corresponds to the generated decision rule, and if the received content does not correspond to the decision rule, may re-request for a content corresponding to the generated decision rule to the content providing apparatus 820.

In addition, the controller 850 may extract data which satisfies a preset condition from among the user context data, and control the query generator 815 to generate a query based on the extracted data.

In other words, the controller 850 may control the query generator 815 to extract the user context test data which satisfies a preset condition from among the user context log data and generate the query based on the extracted user context test data.

Here, the extracted data, that is, the user context test data may include information on a decision rule. Accordingly, the controller 850 may generate the decision rule based on the user context test data, and the controller 850 may generate the decision rule based on at least one of the user context test data and the user information.

The operations of the controller 850 will be described according to each unit contained in the controller 850.

To be specific, the controller 850 may include a decision rule generator 812, a search engine unit 813, and a search result check unit 850.

Herein, the data collector 811 may transmit the user information and the user context data to the decision rule generator 812 and the query generator 815. Accordingly, the query generator 815 may generate the query for searching the content based on the received user information and the user context data. In addition, the decision rule generator 812 may generate a decision rule based on the user information and the user context data. That is, the decision rule generator 812 may generate a decision rule to decide whether a content searched based on the generated query by the query generator 815 satisfies at least one of the user information and the user context data.

In particular, the user context data may include user context log data and user context test data, and the decision rule generator 812 may extract the user context test data which satisfies a preset condition from among the user context log data and generate the decision rule based on at least one of the user information and the user context test data.

Meanwhile, FIG. 8 illustrates that the query generator 815 is not included in the controller 850, but the query generator 815 may be included in the controller 850. In addition, it is described that the query generator 815 generates a query, and the decision rule generator 812 generates the decision rule, but the decision rule generator 812 may generate both the query and the decision rule.

The search engine unit 813 may receive a query generated from the query generator 815, transmit the received query to the content providing apparatus 820, and request search for a content corresponding to the query.

In addition, when the search engine unit 813 receives the content from the content providing apparatus 820 and transmit the result to the search result check unit 814, the search result check unit 814 may determine whether the content satisfies the decision rule generated by the decision rule generator 812.

Herein, the search result check unit 814, if the content does not satisfy the decision rule, may transmit information indicating that the content does not satisfy the decision rule to the search engine unit 813, and the search engine unit 813 may transmit the query to the content providing apparatus 820 and request re-search of the content corresponding to the query.

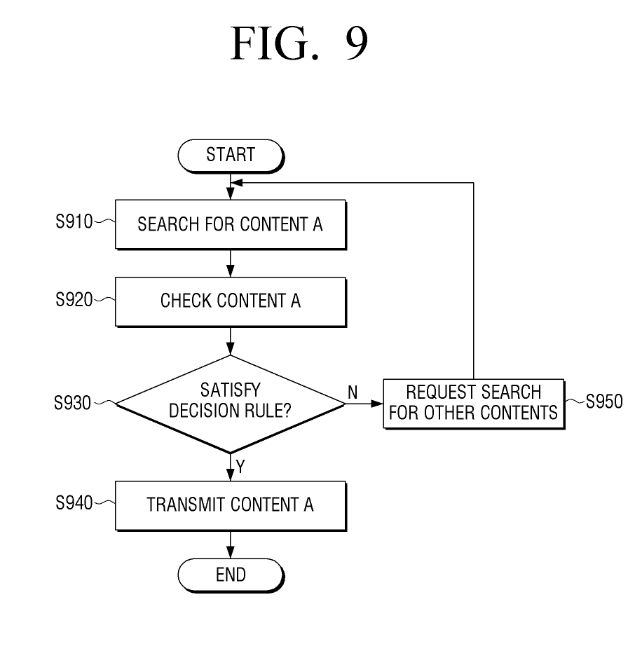

The search result check unit 814, if it is determined that the content satisfies the decision rule, may transmit the content to the user terminal apparatus 830, and accordingly, the user terminal apparatus 830 enables a user to select a content by displaying the received content. The process of determining by the search result check unit 814 whether the content satisfies the decision rule is explained with reference to FIG. 9.

FIG. 9 is a view illustrating a process of determining whether the decision rule is satisfied according to an exemplary embodiment.

Referring to FIG. 9, the search result check unit 814, when the searched content A is inserted (S910), may check content A (S920). To be specific, the search result check unit 814 may check whether the content A is a free content, charged content, a type of the content, and a summary of the content.

In addition, the search result check unit 814 may determine whether the content A satisfies the decision rule (S930). To be specific, the search result check unit 814 may determine whether the content A satisfies at least one of the user information and the user context data, and more specifically, the search result check unit 814 may determine whether the content satisfies at least one of the user context test data which satisfies a preset condition from among the user context log data and the user information.

Meanwhile, the search result check unit 814, when the content A satisfies the decision rule, may transmit the content A to the user terminal apparatus 830 (S940). In addition, the search result check unit 814, when the content A does not satisfy the decision rule, may control the search engine 813 to re-request search for a different content.

Alternatively, the search result check unit 814, when the content A does not satisfy the decision rule, may receive a different decision rule from the decision rule generator 812 and determine whether the content A corresponds to the decision rule.

Meanwhile, FIG. 8 illustrates that the storage 840 exists outside of the server 810, but the storage 840 may be included in the server 810.

The controller 850 may store the user information and the user context data where the user information is processed in the storage 840. In particular, the user context data includes the user context log data and the user context test data, and accordingly, the controller 850 may store each of the user information, the use context log data, and the user context data in the storage 840 by preset groups. For example, the controller 850 may store each of the user information, user context log data, and the user context test data in the storage 840 by groups related to an apparatus. In addition, the controller 850 may store information related to an apparatus by groups in an internal memory. Accordingly, all the information related to a user is stored in the storage 840, and the controller 850 may manage information by groups only, and thus amount to be processed decreases.

Meanwhile, the storage 840 may include user context test data DB 841, user context log data DB 842, and the user information DB 843, and accordingly, the controller 850 may store the user context test data in the user context data DB 841, and store the user context log data in the user context log data DB 842, and store the user information in the user information DB 843. Likewise, as described above, the controller 850 may group each of user information, user context log data, and user context test data by groups, and store in the user context test data DB 841, user context log data DB 842, and the user information DB 843.

In addition, the controller 850, after the data collector 811 collects the user information, controls to process the collected data as user context data, and store the user information and the user context data in the storage 840. In this case, as described above, an example that each of user information, user context log data and user context is stored in the storage 840 by preset groups can be applied in the same manner.

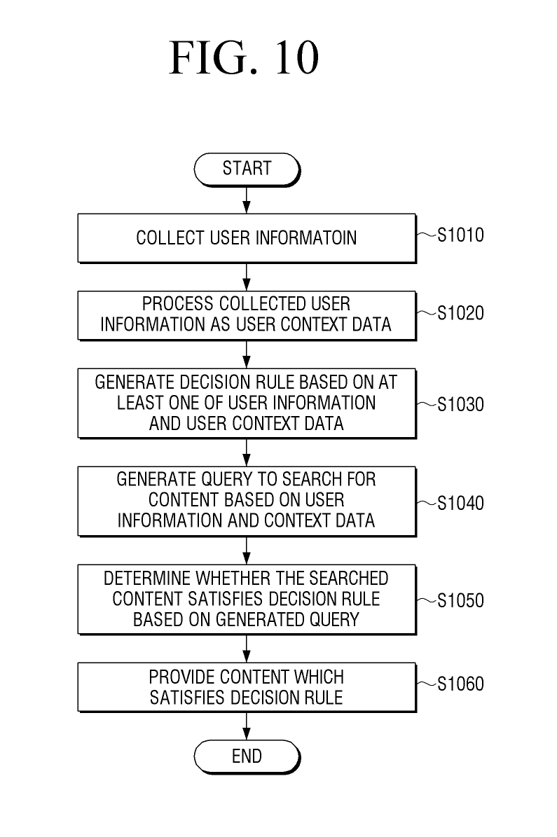

Meanwhile, FIG. 10 is a flowchart to illustrate a controlling method of a content recommendation apparatus according to an exemplary embodiment.

The controlling method of the content recommendation apparatus as illustrated in FIG. 10 collects user information (S1010) and processes the collected user information as user context data (S1020).

Based on at least one of the user information and user context, the decision rule may be generated (S1030).

Here, the user context data includes the user context log data and the user context test data, and the generating the decision rule may include extracting a user context test data which satisfies a preset condition from among user context log data, and generating the decision rule based on at least one of the user information and the user context data.

In addition, based on the user information and the context data, a query for searching the contents is generated (S1040).

In addition, based on the generated query, whether the generated query satisfies the decision rule is determined (S1050).

And the content corresponding to the decision rule is provided (S1060).

The method according to an exemplary embodiment further includes performing communication with a content providing apparatus; wherein the providing may include transmitting the generated query to the content providing apparatus, receiving the content searched based on the query from the content providing apparatus, and providing the d content.

The method according to an exemplary embodiment may further include checking whether a content received from the content providing apparatus satisfies the generated decision rule; and re-requesting for a content satisfying the generated decision rule to the content providing apparatus in response to the received content not satisfying the generated decision rule.

The generating may include extracting data which meets predetermined requirements from the user context data, and generating the query based on the extracted data.

The extracted data may include information regarding the decision rule.

The method according to an exemplary embodiment may further include storing the user information and the user context in which the user information is processed

The user context data may include user context log data and user context test data, wherein the storing may include storing each of the user information, the user context log data, and the user context test data by preset groups.

Here, the user information may include at least one of a gender, an age, an occupation, a voice pattern, a motion pattern, and a face pattern of the user.

The user context data may include data regarding at least one of a voice, a motion, a posture, a facial expression, a viewing content, and a viewing pattern of a user.

The controlling method of the content recommendation apparatus according to the described various exemplary embodiments may be stored in a non-transitory readable medium. The non-transitory readable medium may be used being loaded in various apparatuses.

As an example, a program code for controlling the content recommendation apparatus including an operation of collecting context data of a user, an operation of processing the collected user information as a user text, an operation of generating the decision rule based on at least one of the user information and the context data, an operation of generating a query for searching a content based on the collected context data, an operation of determining whether the content searched based on the generated query satisfies the decision rule, and an operation of providing the content which satisfies the decision rule may be stored in the non-transitory readable medium and may be provided.

The non-transitory readable medium does not refer to a medium storing data for a short moment such as a register, a cache, or a memory, but refers to a medium which is capable of storing data semi-permanently and reading the data by an apparatus. To be more specific, the non-transitory readable medium may be a compact disc (CD), a digital versatile disk (DVD), a hard disk, a Blu-ray disk, a universal serial bus (USB), a memory card, and a read only memory (ROM).

The above-described embodiments may be recorded in computer-readable media including program instructions to implement various operations embodied by a computer. The media may also include, alone or in combination with the program instructions, data files, data structures, and the like. The program instructions recorded on the media may be those specially designed and constructed for the purposes of embodiments, or they may be of the kind well-known and available to those having skill in the computer software arts. Examples of computer-readable media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. The computer-readable media may also be a distributed network, so that the program instructions are stored and executed in a distributed fashion. The program instructions may be executed by one or more processors. The computer-readable media may also be embodied in at least one application specific integrated circuit (ASIC) or Field Programmable Gate Array (FPGA), which executes (processes like a processor) program instructions. Examples of program instructions include both machine code, such as produced by a compiler, and files containing higher level code that may be executed by the computer using an interpreter. The above-described devices may be configured to act as one or more software modules in order to perform the operations of the above-described embodiments, or vice versa.

The foregoing exemplary embodiments and advantages are merely exemplary and are not to be construed as limiting the present inventive concept. The exemplary embodiments can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A content recommendation apparatus, comprising:
a data collector configured to collect user information and process the collected user information as user context data;
a query generator configured to generate a query for searching a content based on the user information and the user context data; and
a controller configured to generate a decision rule to decide whether a content searched based on the generated query satisfies at least one of the user information and the user context data, and provide a content which satisfies the decision rule.

2. The apparatus as claimed in claim 1, wherein the user context data comprises user context log data and user context test data,
wherein the controller extracts the user context test data which satisfies a preset condition from among the user context log data, and generates the decision rule based on at least one of the user information and the user context test data.

3. The apparatus as claimed in claim 2, further comprising:
a communicator configured to perform communication with a content providing apparatus;
wherein the controller transmits the generated query to the content providing apparatus, receives the recommended content searched based on the query from the content providing apparatus, and provides the content.

4. The apparatus as claimed in claim 2, wherein the controller checks whether the content received from the content providing apparatus satisfies the decision rule, and in response to the content received from the content providing apparatus not satisfying the decision rule, re-requests for a content satisfying the generated decision rule from the content providing apparatus.

5. The apparatus as claimed in claim 1, wherein the controller controls the query generator to extract data which meets predetermined requirements from the user context data and to generate the query based on the extracted data.

6. The apparatus as claimed in claim 5, wherein the extracted data comprises information regarding the decision rule.

7. The apparatus as claimed in claim 1, further comprising:
a storage unit,
wherein the controller stores the user information and the user content data in which the user information is processed to the storage unit.

8. The apparatus as claimed in claim 7, wherein the user context data comprises user context log data and user context test data,
wherein the controller stores each of the user context log data and the user context test data by preset groups.

9. The apparatus as claimed in claim 1, wherein the user information includes at least one of a gender, an age, an occupation, an income, a voice pattern, a motion pattern, and a face pattern of the user.

10. The apparatus as claimed in claim 1, wherein the user context data include data of at least one of a voice, a motion, a posture, a facial expression, a viewing content, and a viewing pattern of the user.

11. A method of a controlling a content recommendation apparatus, comprising:
collecting user information;
processing the collected user information to user context data;
generating a decision rule based on at least one of the user information and the user context data;
generating a query for searching a content based on the user information and the context data;
determining whether a content searched based on the generated query satisfies the decision rule; and
providing a content which satisfies the decision rule.

12. The method as claimed in claim 11, wherein the user context data comprises user context log data and user context test data,
wherein the generating the decision rule comprises extracting the user context test data which satisfies a preset condition from among the user context log data, and generating the decision rule based on at least one of the user information and the user context test data.

13. The method as claimed in claim 12, further comprising:
performing communication with a content providing apparatus;
wherein the providing comprises transmitting the generated query to the content providing apparatus, receiving the content searched based on the query from the content providing apparatus, and providing the d content.

14. The method as claimed in claim 13, further comprising:
checking whether a content received from the content providing apparatus satisfies the generated decision rule; and
re-requesting for a content satisfying the generated decision rule to the content providing apparatus in response to the received content not satisfying the generated decision rule.

15. The method as claimed in claim 11, wherein the generating comprises extracting data which meets predetermined requirements from the user context data, and generating the query based on the extracted data.

16. The method as claimed in claim 15, wherein the extracted data comprises information regarding the decision rule.

17. The method as claimed in claim 11, further comprising:
storing the user information and the user context in which the user information is processed.

18. The method as claimed in claim 17, wherein the user context data comprises user context log data and user context test data,
wherein the storing comprises storing each of the user information, the user context log data, and the user context test data by preset groups.

19. The method as claimed in claim 11, wherein the user information includes at least one of a gender, an age, an occupation, a voice pattern, a motion pattern, and a face pattern of the user.

20. The method as claimed in claim 11, wherein the context data include data of at least one of a voice, a motion, a posture, a facial expression, a viewing content, and a viewing pattern of the user.
